(19) United States
(12) Patent Application Publication
(10) Pub. No.: US 2017/0300914 A1
(43) Pub. Date: Oct. 19, 2017

(54) METHOD, CLIENT, SERVER AND COMPUTER STORAGE MEDIUM FOR PROCESSING INFORMATION

(71) Applicant: TENCENT TECHNOLOGY (SHENZHEN) COMPANY LIMITED, Shenzhen (CN)

(72) Inventors: Xiaoming Li, Shenzhen (CN); Haopeng Liu, Shenzhen (CN)

(21) Appl. No.: 15/636,147

(22) Filed: Jun. 28, 2017

Related U.S. Application Data
(63) Continuation of application No. PCT/CN2016/081425, filed on May 9, 2016.

(30) Foreign Application Priority Data
Jun. 15, 2015 (CN) 201510330318.0

(51) Int. Cl. G06Q 20/40; G06Q 20/32

(52) U.S. Cl. CPC G06Q 20/4014; G06Q 20/3276

(57) ABSTRACT

The disclosure relates to an information processing method, a client, a server and a computer storage medium. The method includes that: a service application detects a payment operation; payment information is acquired in response to the payment operation; a payment request is formed according to the payment information; and the payment request is sent, the payment request being sent to a payment account bound to the service application for payment.

### CROSS-REFERENCE TO RELATED APPLICATIONS

This is a continuation application of International Patent Application No. PCT/CN2016/081425, filed on May 9, 2016, which claims priority to Chinese Patent Application No. 201510330318.0, filed on Jun. 15, 2015 and entitled “Information Processing Method, Client, Server, and Computer Storage Medium.” The disclosures of these applications are incorporated by reference herein in their entirety.

### BACKGROUND

With the development of an information technology and a communication technology, shopping, specifically for example, advertisement shopping, is performed online increasingly. When performing payment for the advertisement shopping, a user may need to scan information such as a payment quick response (QR) code displayed on a television or a computer via WeChat on a mobile phone for payment. Alternatively, the user needs to quit playing a video temporarily, and enters a payment account filling page to fill in payment information. The user aligns the mobile phone with the television or the computer to scan the payment QR code or the user fills in a payment account by using a remote controller. Apparently, these payment operations are very complicated. The intelligence of a client such as the television or the computer is low, the usage satisfaction of the user is low, and the enthusiasm of the user for television shopping is greatly dampened.

### SUMMARY

The disclosure relates to the field of information, and in particular, to an information processing method, a client, a server and a computer storage medium.

In view of this, the embodiments of the disclosure are intended to provide an information processing method, a client, a server and a computer storage medium, which at least partially solve the problems of low intelligence of a client and low usage satisfaction of a user.

The technical solutions of the disclosure are implemented as follows.

According to a first aspect of an embodiment of the disclosure, an information processing method is provided, which may include that: a service application detects a payment operation; payment information is acquired in response to the payment operation; a payment request is formed according to the payment information; and the payment request is sent, the payment request being sent to a payment account bound to the service application for payment.

Optionally, the step that a service application detects a payment operation may include that: when multimedia information is played, a payment operation for the multimedia information is detected.

Optionally, the method may further include that: a binding relationship between the service application and the payment account is established before the service application detects the payment operation.

Optionally, the step that a binding relationship between the service application and the payment account is established before the service application detects the payment operation may include that: identification information of the payment account is received; and the identification information is sent to a server, the identification information being used for establishing, by the server, a binding relationship between the service application and the payment account.

Optionally, the method may further include that: after payment succeeds on the basis of the payment request, information for indicating payment success is output.

Optionally, the method may further include that: when the payment account does not perform payment for the payment request for a specified time period, information for prompting payment or information for cancelling payment is output.

According to a second aspect of an embodiment of the disclosure, an information processing method is provided, which may include that: a payment request sent by a service application is received; a payment account by which the payment request will be received is determined, wherein the payment account is bound to the service application; and the payment account and the payment request are sent to a payment platform, the payment request being sent to the payment account via the payment platform for payment.

Optionally, the step that a payment account by which the payment request will be received is determined may include that: a payment account bound to the service application is queried according to identification information of the service application.

Optionally, the method may further include that: before the payment request sent by the service application is received, a binding relationship between the service application and the payment account is established.

Optionally, the step that a binding relationship between the service application and the payment account is established may include that: identification information, sent by the service application, of the payment account is received; and the identification information of the service application and identification information of the payment account are stored with correspondence to each other.

Optionally, the step that a payment account by which the payment request will be received is determined may include that: the identification information, sent by the service application, of the payment account is parsed, and the payment account is determined.

Optionally, the method may further include that: a payment response which is representative of Having Paid and sent by the payment account via the payment platform is received; information for indicating payment success is formed according to the payment response; and the information for indicating payment success is sent to the service application, the information for indicating payment success being displayed on a client where the service application runs.

Optionally, the method may further include that: when a payment response is not received from the payment account for a specified time period, information for prompting payment or information for cancelling payment is formed; and the information for prompting payment or the information for cancelling payment is sent to at least one of the payment account and the service application, the information for prompting payment being displayed on a client where the service application runs or a client where the payment account runs, and the information for cancelling payment being displayed on the client where the service application runs or the client where the payment account runs.

According to a third aspect of an embodiment of the disclosure, a client is provided, which may include: a detection module, configured to detect a payment operation through a service application; a response module, configured to acquire payment information in response to the payment operation; a forming module, configured to form a payment request according to the payment information; and a first sending module, configured to send the payment request, the payment request being sent to a payment account bound to the service application for payment.

Optionally, the detection module may be configured to detect, when multimedia information is played, a payment operation for the multimedia information.

Optionally, the client may further include: a first establishment module, configured to establish, before the service application detects the payment operation, a binding relationship between the service application and the payment account.

Optionally, the first establishment module may be configured to receive identification information of the payment account, and send the identification information to a server, the identification information being used for establishing, by the server, a binding relationship between the service application and the payment account.

Optionally, the client may further include: an output module, configured to output, after payment succeeds on the basis of the payment request, information for indicating payment success.

Optionally, the client may further include: an output module, configured to output, when the payment account does not perform payment for the payment request for a specified time period, information for prompting payment or information for cancelling payment.

According to a fourth aspect of an embodiment of the disclosure, a server is provided, which may include: a receiving module, configured to receive a payment request sent by a service application; a determination module, configured to determine a payment account by which the payment request will be received, wherein the payment account is bound to the service application; and a second sending module, configured to send the payment account and the payment request to a payment platform, the payment request being sent to the payment account via the payment platform for payment.

Optionally, the determination module may be configured to query a payment account bound to the service application according to identification information of the service application.

Optionally, the server may further include: a second establishment module, configured to establish, before the payment request sent by the service application is received, a binding relationship between the service application and the payment account.

Optionally, the second establishment module may be configured to receive identification information, sent by the service application, of the payment account is received, and store the identification information of the service application and identification information of the payment account with correspondence to each other.

Optionally, the determination module may be configured to parse the identification information, sent by the service application, of the payment account, and determine the payment account.

Optionally, the server may further include a forming module; the receiving module may be further configured to receive a payment response which is representative of Having Paid and sent by the payment account via the payment platform; the forming module may be further configured to form information for indicating payment success according to the payment response; and the second sending module may be further configured to send the information for indicating payment success to the service application, the information for indicating payment success being displayed on a client where the service application runs.

Optionally, the server may further include a forming module; the forming module may be further configured to form, when a payment response is not received from the payment account for a specified time period, information for prompting payment or information for cancelling payment; and the second sending module may be further configured to send the information for prompting payment or the information for cancelling payment to at least one of the payment account and the service application, the information for prompting payment being displayed on a client where the service application runs or a client where the payment account runs, and the information for cancelling payment being displayed on the client where the service application runs or the client where the payment account runs.

According to a fifth aspect of an embodiment of the disclosure, there is provided a computer storage medium having stored thereon computer-executable instructions for executing at least one of the aforementioned information processing methods.

According to the information processing method, the client, the server and the computer storage medium in the embodiments of the disclosure, a payment account finally forwarded by a payment request will be formed via a simple payment operation, so the operation complexity for a user to scan a payment identifier via an electronic device such as a mobile phone or to enter a specific page for payment is avoided, and the intelligence of the electronic device and the usage satisfaction of the user are improved.

### BRIEF DESCRIPTION OF THE DRAWINGS

FIG. 1 is a first flowchart of an information processing method according to an embodiment of the disclosure;

FIG. 2 is a first flowchart of establishment of a binding relationship according to an embodiment of the disclosure;

FIG. 3 is a second flowchart of an information processing method according to an embodiment of the disclosure;

FIG. 4 is a third flowchart of an information processing method according to an embodiment of the disclosure;

FIG. 5 is a structural diagram of a client according to an embodiment of the disclosure;

FIG. 6 is a structural diagram of a server according to an embodiment of the disclosure; and

FIG. 7 is a structural diagram of a communication system according to an embodiment of the disclosure.

### DETAILED DESCRIPTION

In order to solve the problems of complicated payment operation and low client intelligent in a payment process such as advertisement shopping in an embodiment of the present application, an information processing method is provided in the present embodiment. A payment operation of a user is detected, the payment operation may be a simple push-to-trigger operation compared to scanning information such as a payment QR code or filling in information such as a payment account, payment information is automatically acquired to form a payment request, and the payment request is finally sent to a payment account of a mobile phone or pad of the user via a payment platform or other modes for payment. The user operation is simplified, and the intelligence of an electronic device is improved. The technical solutions of the disclosure will be further elaborated hereinbelow in conjunction with the drawings of the description and specific embodiments. It is to be understood that preferred embodiments illustrated hereinbelow are merely used for illustrating and explaining the disclosure, and are not used for limiting the disclosure.

### Method Embodiment 1

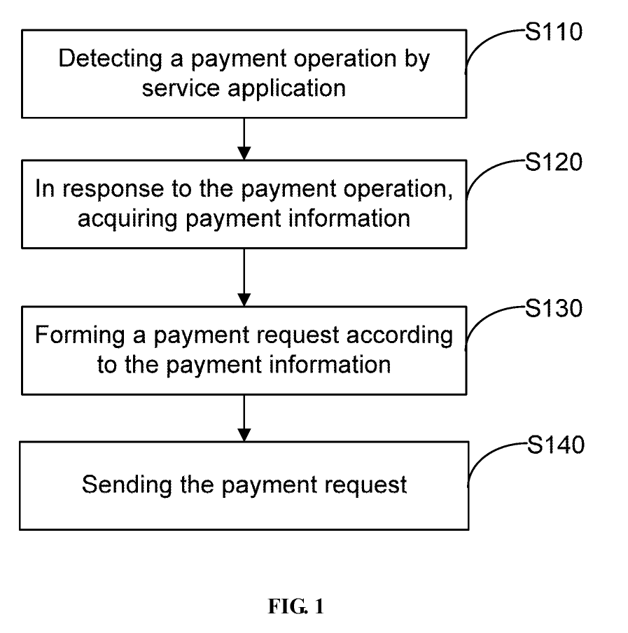

As shown in FIG. 1, the present embodiment provides an information processing method, which includes steps S110-S140.

In the step S110, a service application detects a payment operation.

In the step S120, payment information is acquired in response to the payment operation.

In the step S130, a payment request is formed according to the payment information.

In the step S140, the payment request is sent.

The payment request is sent to a payment account bound to the service application for payment.

The information processing method in the present embodiment may be applied to a client such as a network television or various computers. The client performing the step S110 to the step S140 in the present embodiment may be supposed as a first client.

The service application detects a payment operation. The payment operation here may be a push-to-trigger payment operation. If a television plays a shopping advertisement, a user sends a payment instruction to the television via a remote controller. For example, the user may send the payment instruction by pressing a specific key on the remote controller. When the television receives the payment instruction, it is regarded that the payment operation is received.

In the step S120, payment information will be acquired in response to the payment operation. The payment information here may include a payment link or payment identification information, etc.

In the step S130, a payment request will be formed.

Specifically, for example, a television is playing a liquor advertisement, and after seeing the liquor advertisement, Xiaoming wants to purchase the liquor. In the conventional art, when the television is playing the liquor advertisement, a payment QR code for paying for the liquor may be displayed. If Xiaoming wants to purchase the liquor, he needs to approach the television, scan the payment QR code by means of a payment application such as a mobile phone WeChat or a mobile phone QQ, and enter a shopping page for purchasing by means of the scanned payment QR code. Apparently, the operation flow is complicated. If the method in the present application is utilized, Xiaoming may send a payment instruction to the television by means of an enter key in a remote controller. The television will automatically acquire payment information and form a payment request containing the payment information. In the present example, the television will automatically scan the payment QR code, and send the payment QR code to a WeChat account of Xiaoming's mobile phone finally. So, Xiaoming can acquire the payment QR code and can enter a shopping page for payment, without scanning a payment QR code displayed on the television. Apparently, the intelligence of the television watched by Xiaoming is higher, thereby simplifying the shopping operation for Xiaoming, and improving the degree of satisfaction of Xiaoming's shopping payment experience. In a word, clients where the service application and the payment account run currently may be different from each other in the present embodiment. For example, the service application runs in a first client, and the payment account runs in a second client. In this way, the second client will acquire information such as a payment identifier or a payment link or order information, which is related to payment, without directly scanning information displayed by the first client. The second client may receive a payment request which is formed via background execution and sent by the first client after detecting the payment operation.

Certainly, provided that the service application is bound to Xiaoming's payment account, it can be ensured that the payment request is sent to Xiaoming's payment account. The binding relationship between the service application and the payment account may be established in the client where the service application runs, or may be established in server serving the first client. For example, in a television box of a network television in Xiaoming's house, Xiaoming's payment account is pre-stored, so a binding relationship between the service application running in the television box of the network television in Xiaoming's house and Xiaoming's payment account is established. In such case, if the first client forwards the payment request via a server and/or a payment platform, the first client will send the payment account along with the payment request to the server and/or the payment platform. Certainly, alternatively, the binding relationship may be established in the server or the payment platform. In this case, the first client only needs to send the payment request to the server and/or the payment platform, and the server and/or the payment platform forward(s) the payment request. If the first client is adopted to establish and store the binding relationship between the service application and the payment account, loads of the server and/or the payment platform can be reduced.

The payment account in the present embodiment may be a WeChat account, a QQ account, an alipay account, a tenpay account or other accounts having a payment function.

Usually, the payment request in the present embodiment may be information capable of directly performing payment in a payment interface of the payment account or under a payment state, for example, payment identification information capable of being displayed and identified in a WeChat payment interface, or a payment link or an order link capable of being directly activated in WeChat.

The step that the payment request is sent in Step S140 may occur in various situations. In one situation, the first client executing the information processing method in the present embodiment can directly communicate with an electronic device running the payment account. In this case, the first client may directly send a payment request to the payment account. If the first client cannot be directly connected to the electronic device running the payment account, the payment request may be sent and may be transferred via a payment platform. Specifically, for example, the payment request is transferred by a WeChat platform or a QQ platform, and sent to the payment account finally by transfer via the payment platform. So, in Step S140, the payment request is probably sent to the payment platform.

The payment request is sent to the payment account in various manners specifically. Several optional manners are provided hereinbelow.

Optional Manner 1:

The service application sends the payment request to the payment account via the payment platform.

Specifically, it is supposed that the aforementioned payment account is WeChat account A. The service application may send the payment request to WeChat account A via a WeChat platform by utilizing WeChat account B capable of communicating with WeChat account A. The WeChat platform here is the payment platform. WeChat account A is a payment account for information interaction between payment information formed on the basis of the service application and WeChat account B. The WeChat account and the service application may run in the same first client. Alternatively, the service application runs in the first client, while WeChat account B runs in a server serving the first client.

If WeChat account B and the service application run in the same first client, the first client sends a payment request to the WeChat platform via WeChat account B after the service application forms the payment request, and forwards the payment request to WeChat account A via the WeChat platform.

If the service application runs in the first client while WeChat account B runs in a server serving the first client, the first client also needs to send the payment request to the server, the server forwards the payment request to the WeChat platform, and the WeChat platform finally sends the payment request to WeChat account A.

Optional Manner 2:

If the first client running the service application can directly communicate with the second client running the payment account, the first client may directly send the payment request to the second client where the payment account runs. Specifically, for example, a television box of a network television sends the payment request to a mobile phone where the payment account runs. Specifically, for example, the payment request may be sent in a household WiFi, a Bluetooth or an infrared ray. Certainly, alternatively, the payment request may be sent through Internet.

The payment account enters a payment interface based on the payment request, for performing payment.

Apparently, the information processing method in the present embodiment greatly improves the intelligence of the first client during payment, and improves the usage satisfaction of the user.

### Method Embodiment 2

As shown in FIG. 1, the present embodiment provides an information processing method, which includes the following steps S110-S140.

In the step S110, a service application detects a payment operation.

In the step S120, payment information is acquired in response to the payment operation.

In the step S130, a payment request is formed according to the payment information.

In the step S140, the payment request is sent.

The payment request will be sent to a payment account bound to the service application for payment.

The step S110 includes that: when multimedia information is played, a payment operation for the multimedia information is detected.

The multimedia information here may include multimedia information such as a video or a picture.

For example, when an advertisement video is pre-played or inter-cut in a process of playing a variety show, a teleplay or a movie on a television or a computer, a user may watch a video (i.e., the aforementioned variety show, teleplay or movie) specified by the user after an advertisement is completely played. In a video advertisement watching process, the user wants to purchase a commodity advertised in the advertisement video. In this case, the user may send to the first client, where the service application runs, an instruction about a payment operation via a remote controller or a keyboard.

During payment via the information processing method in the present embodiment, playing of the multimedia information may not be stopped, and the user does not need to approach the television or the computer to scan a pay QR code or switch to other pages of the television to fill in payment information. Apparently, according to the information processing method in the present embodiment, when the first client forms the payment request, playing of the multimedia information does not need to be paused, and the payment request is formed in background and sent in the background, so a user nearby watching the multimedia information will not be influenced. Certainly, it is judged whether the payment request is successfully sent, and a message indicative of successful sending of the payment request may be output on the premise of keeping the multimedia information played. Output here may refer to: superposed displaying of the message, which is indicative of successful sending of the payment request, on the multimedia information. Certainly, in this case, a corner position where the multimedia information is played is selected for displaying the message usually.

For example, when a television program “Tiger Mum” is being played on a television, a red wine advertisement is inter-cut. User A watching the program wants to purchase the red wine, yet user B watching the program wants to continuously watch the program after the red wine advertisement is completely played. If the conventional method is adopted, the television may switch to other pages, which may influence watching of user B. In contrast, if the information processing method in the present embodiment is adopted, the problem does not need to be concerned at all. The step S110 to step S130 may be completed at the background of the television.

Apparently, the information processing method in the present embodiment improves the intelligence of the electronic device and the usage satisfaction of the user.

### Method Embodiment 3

As shown in FIG. 1, the present embodiment provides an information processing method, which includes the following steps S110-S140.

In the step S110, a service application detects a payment operation.

In the step S120, payment information is acquired in response to the payment operation.

In the step S130, a payment request is formed according to the payment information.

In the step S140, the payment request is sent.

The payment request will be sent to a payment account bound to the service application for payment.

The method further includes that: before the service application detects the payment operation, a binding relationship between the service application and the payment account is established.

There are many methods for establishing the binding relationship between the service application and the payment account. Two optional manners are provided hereinbelow.

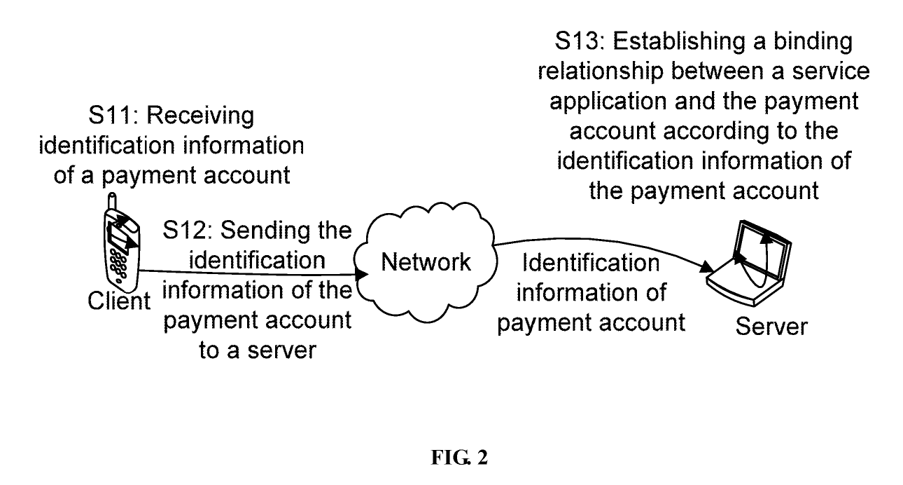

As shown in FIG. 2, optional manner 1 includes the following steps.

In the step S11, identification information of the payment account is received. In the step S12, the identification information of the payment account is sent to a server.

The identification information of the payment account is used by the server for establishing a binding relationship between the service application and the payment account. In FIG. 2, a step S13 of establishing, by the server, a binding relationship between the service application and the payment account according to the identification information of the payment account is included.

The server may be an electronic device serving the service application. The service application may be a video playing application. For example, in a network television, the service application may be an application in a television box or a smart television. The server may be a server providing video playing service for the network television or the smart television.

In the present embodiment, when the user does not watch a video, the user may input the identification information of the payment account via a remote controller or a key on a television set or the client where the service application runs.

When the identification is received by the service application, the identification information will be sent to the server. The server will store identification information of the service application and identification information of the payment account with correspondence to each other, so the identification information of the payment account may be queried according to the identification information of the service application subsequently, thereby implementing a binding relationship between the service application and the payment account. During specific implementation, a service application may be bound to one or more payment accounts. When the service application is bound to more payment accounts, during detection of the payment operation, the user may also instruct a specific one of the payment accounts for payment via a remote controller or a mobile phone.

Manner 2:

Specifically, for example, the server runs an official account, and the official account and the payment account are communication accounts of the same type.

The server will form identification information, such as a QR code or a bar code, for uniquely identifying the service application.

The client where the service application is located will store the identification information of the service application and identification information of the official account.

So, the user establishes a communication between the payment account and the official account firstly by scanning the identification information of the official account, and then sends the identification information of the service application to the official account. Thus, the server where the official account is located will store the identification information of the service application and the identification information of the payment account to complete establishment of the binding relationship.

Apparently, the present embodiment provides a binding relationship establishment method having advantage of simple implementation.

### Method Embodiment 4

As shown in FIG. 1, the present embodiment provides an information processing method, which includes the following steps S110-S140.

In the step S110, a service application detects a payment operation.

In the step S120, payment information is acquired in response to the payment operation.

In the step S130, a payment request is formed according to the payment information.

In the step S140, the payment request is sent.

The payment request will be sent to a payment account bound to the service application for payment.

During specific implementation, a user may ask someone for help in payment by means of the information processing method in the present embodiment. Specifically, for example, Xiaomin does not have a payment account or her payment account is not bound to the service application. However, Xiaoming has a payment account which has been bound to the service application. In this case, Xiaoming is at work, and Xiaomin is watching TV at home. Xiaoming may control a television to send a payment request to Xiaoming's payment account via a server and a payment platform by means of an instruction for sending the payment operation to the television. In this case, Xiaoming is asked for help in payment. At this time, how to make Xiaomin know that Xiaoming has completed payment is a problem. In the present embodiment, in order to solve the problem, the method further includes that: after payment succeeds on the basis of the payment request, information for indicating payment success is output.

Apparently, if seeing the information for indicating payment success, Xiaomin will know that Xiaoming has completed payment. Certainly, Xiaomin may utilize her payment account for payment, or may know that she has succeeded in payment by means of the information for indicating payment success displayed by the client where the service application is located.

Herein, the information for indicating payment success may be performed in an output manner such as a display output manner or audio prompt output manner.

The information processing method in the present embodiment improves the intelligence of an electronic device and the usage satisfaction of the user by outputting the information for indicating payment success.

In some embodiments, the method further includes that: when the payment account does not perform payment for the payment request for a specified time period, information for prompting payment or information for cancelling payment is output. The information for prompting payment and the information for cancelling payment may correspond to different pieces of information, or may correspond to a single piece of information having a prompt function or judging whether to cancel payment. Output here may be performed in an output manner such as a display output manner or audio prompt output manner.

The user can be prompted to pay in time or cancel shopping by means of output of the information for prompting payment or the information for cancelling payment. Thus, good interaction with the user is implemented, thereby improving the intelligence of the electronic device and the usage satisfaction of the user.

During specific implementation, when at least one of the information for indicating payment success, the information for prompting payment and the information for cancelling payment is output by using a client which is outputting multimedia information or through which a web page is browsed, the display output manner may be adopted, so information interference to work being currently handled by the client is reduced to the greatest extent. Specifically, for example, when a user is watching a variety show by using a network television or a smart television, if a voice prompt is inter-cut suddenly to prompt the user for payment, the user may feel disgusted. However, if information for prompting payment is output at an edge display position of the smart television or the network television in a rolling manner during playing of the variety show, the aim of user prompt may be achieved, and over-large interference to the variety show being watched by the user can be avoided, thereby improving the usage satisfaction of the user again.

In conclusion, method embodiment 1 to method embodiment 4 provide a method for smartly assisting, by a client, a user in payment, thereby improving the intelligence of the client, simplifying the user operation, and improving the usage satisfaction of the user.

### Method Embodiment 5

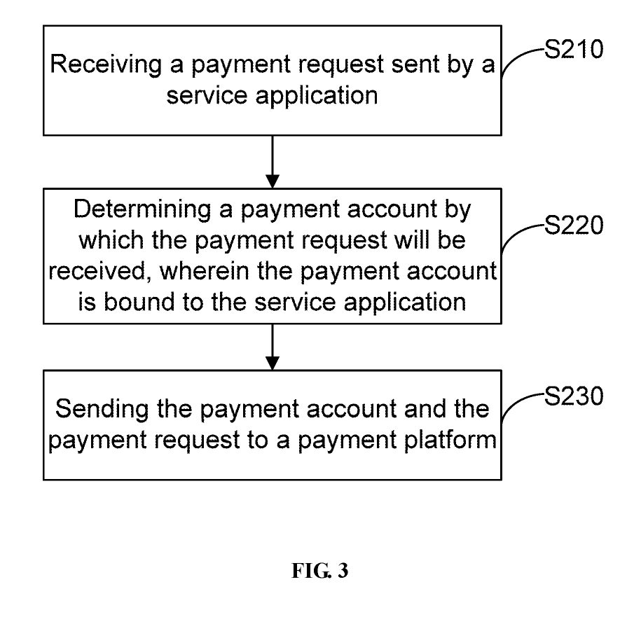

As shown in FIG. 3, the present embodiment provides an information processing method, which includes the following steps S210-S230.

In the step S210, a payment request sent by a service application is received.

In the step S220, a payment account by which the payment request will be received is determined, wherein the payment account is bound to the service application.

In the step S230, the payment account and the payment request are sent to a payment platform.

The payment request will be sent to the payment account via the payment platform for payment.

The information processing method in the present embodiment may be applied to a server connected to a client to which the information processing methods in method embodiment 1 to method embodiment 4 are applied.

For example, the information processing methods in method embodiment 1 to method embodiment 4 are applied to a playing client of QQLive. The service application is a QQLive application. The information processing method in the present embodiment may be a server for providing QQLive playing service. The server in the present embodiment runs a communication account capable of communicating with the payment account. Specifically, if the payment account is a QQ account, the server also runs a QQ account, and these two QQ accounts may communicate with each other via a QQ platform.

In the present embodiment, the server will receive a payment request sent by a service application. The payment request here may include payment information. The payment information may include a payment link, payment identification information or an order to be paid. After receiving the payment request, the server determines a service application, which has sent the payment request, according to information contents carried in the payment request or a sending path of the payment request, so the service application which has sent the payment request can be determined. The payment account is queried in a pre-stored binding relationship between a payment application and a payment account according to identification information of the service application. In this case, the payment request is sent to the payment account, so information needing to be known in a payment process can be sent to the payment account for payment.

In the present embodiment, a payment account by which the payment request will be received is determined in Step S220.

There are many manners for determining the payment account specifically. Here, two optional manners are provided.

Optional Manner 1:

A binding relationship between the service application and the payment account is pre-established and stored in the server. At this time, the server may query the payment account bound to the service application according to identification information of the service application.

In a specific implementation process, the server may pre-allocate identification information for uniquely identifying the service application to each service application provided by the server. In such a way, when communicating with a service application, the server will know what the service application is. Specifically, the server receives a request for establishing a binding relationship with the service application, and the server allocates identification information of a service application to the service application in response to the request for establishing the binding relationship, and sends the identification information of the service application to the service application. So, when the service application communicates with the server subsequently, the operation is executed according to the identification information of the service application. In addition, the server will receive identification information of a payment account sent by a client, and stores the identification information of the service application and the identification information of the payment account with correspondence to each other, thereby establishing a binding relationship between the service application and the payment account.

Optional Manner 2:

The step S220 may include that the payment account is received from the service application. The binding relationship between the service application and the payment account is established and stored in the service application.

So, in the step S220, determination may be made by receiving the identification information of the payment account sent by the service application. The identification information of the payment account may be received together with the payment request, or may be received before or after the payment request.

So, in the step S220, a specific payment account to which a payment request sent by a current service application is sent may be determined in a query or receiving manner. In a word, these two manners may be used by the server for simply determining the payment account.

Step S230 may specifically include that: the server sends the payment account along with the payment request to a payment platform. The payment platform is a communication platform for forwarding the payment request to the payment account.

Apparently, in the present manner, the server does not directly send a payment request to a client where the payment account is located, and instead, the server forwards the payment request via the payment platform. Specifically, for example, the payment platform may be a WeChat platform. A WeChat official account runs on the server. The WeChat official account here may be understood as a WeChat group account, mainly a WeChat account provided for applications of groups such as enterprises, or other organizations.

For another example, the payment account is a communication identification number such as a phone number. Certainly, the phone number may implement payment in bill payment and deduction modes. The server may send the payment request to the payment account by sending a short message to the payment account. Certainly, the present manner is processed via a network communication platform such as a base station.

The identification information of the service application in the present embodiment may be identification information which is generated by the server and is capable of uniquely identifying each service application in the client, thereby facilitating subsequent communication and identification between the server and the client.

In a word, the information processing method in the present embodiment can simplify the user operation, improve the intelligence of the server, better utilize software and hardware resources of the server, and improve optimal resource configuration of the server.

### Method Embodiment 6

As shown in FIG. 3, the present embodiment provides an information processing method, which includes the following steps S210-S220.

In the step S210, a payment request sent by a service application is received. In the step S220, a payment account by which the payment request will be received is determined, wherein the payment account is bound to the service application.

In the step S230, the payment account and the payment request are sent to a payment platform.

The payment request will be sent to the payment account via the payment platform for payment.

The method further includes that: before the payment request sent by the service application is received, a binding relationship between the service application and the payment account is established.

A binding relationship between the service application and the payment account is also established by the server in the present embodiment. The binding relationship includes a mapping relationship established between identification information of the service application and identification information of the payment account. So, when the payment request of the service application is received, the payment account to which the current payment request is to be sent may be determined according to the identification information of the service application.

In the information processing method in the present embodiment, the server participates in determination of the payment account by pre-establishing the binding relationship between the service application and the payment account.

For details of how to establish the binding relationship specifically, the following method may be referred to.

The server receives identification information, sent by the service application, of the payment account.

The identification information of the service application and identification information of the payment account are stored with correspondence to each other.

The storage with correspondence to each other here at least refers to that the corresponding identification information of the payment account can be queried according to the identification information of the service application.

Specifically, for example, the server establishes a form in which a record row represents a binding relationship. Identification information of a service application and identification information of a payment account are stored in the record row.

During specific implementation, a situation where a binding relationship is established between a service application and several payment accounts may occur. Under this situation, the server may also receive a query mark for indicating which payment account in payment accounts bound to the service application is used for payment.

The query mark may be a key field or first field of the payment account or a binding sequence. Specifically, for example, service application A is bound to payment account A, account B and account C. When a payment request is received, query mark 3 is also received. 3 here represents the third payment account bound to the service application.

In a word, the method in the present embodiment is a method for establishing a binding relationship on the basis of the aforementioned embodiment, which has advantage of simple implementation.

### Method Embodiment 7

As shown in FIG. 3, the present embodiment provides an information processing method, which includes the following steps S210-230.

In the step S210, a payment request sent by a service application is received. In the step S220, a payment account bound to the service application is queried according to the identification information of the service application.

In the step S230, the payment account and the payment request are sent to a payment platform.

The payment request will be sent to the payment account via the payment platform for payment.

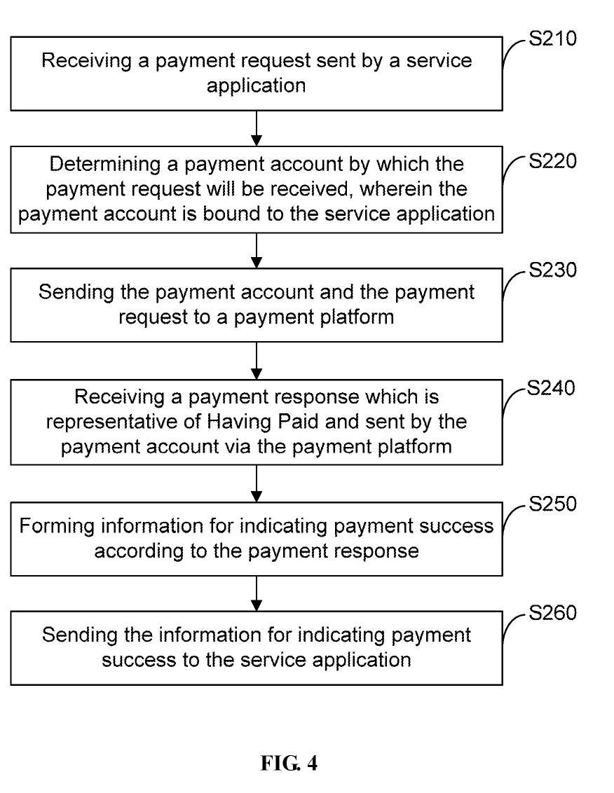

As shown in FIG. 4, the method further includes the following steps S240-260.

In the step S240, a payment response which is representative of Having Paid and sent by the payment account via the payment platform is received.

In the step S250, information for indicating payment success is formed according to the payment response.

In the step S260, the information for indicating payment success is sent to the service application.

The information for indicating payment success will be displayed on a client where the service application runs.

In the present embodiment, the payment response represents that the corresponding payment account agrees to payment and specifies a payment operation, specifically for example, an operation of triggering a journal cash account.

Information for indicating payment success is formed in Step S250 and sent to the service application, thereby facilitating output of a client where the service application runs so as to inform a user of a current payment situation, so the intelligence of the server and the client is improved, and the usage satisfaction of the user is improved.

Meanwhile, the method further includes the following steps S270-S280.

In the step S270, when a payment response is not received from the payment account for a specified time period, information for prompting payment or information for cancelling payment is formed.

In the step S280, the information for prompting payment or the information for cancelling payment is sent to at least one of the payment account and the service application.

The information for prompting payment will be displayed on a client where the service application runs or a client where the payment account runs.

The information for cancelling payment will be displayed on the client where the service application runs or the client where the payment account runs.

Thus, the user can be prompted to pay in time or payment cancellation is determined, thereby avoiding the problem that a payment process cannot be carried out; more prompts are provided for the user, the time delay for payment can be reduced, software and hardware resources of the server and the client are better re-utilized, and the usage satisfaction of the user is improved.

### Device Embodiment 1

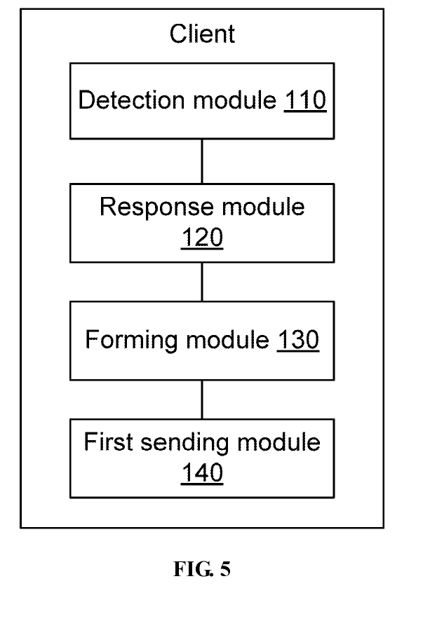

As shown in FIG. 5, the present embodiment provides a client, which includes a detection module 110, a response module 120, a forming module 130 and a first sending module 140.

The detection module 110 is configured to detect a payment operation through a service application.

The response module 120 is configured to acquire payment information in response to the payment operation.

The forming module 130 is configured to form a payment request according to the payment information.

The first sending module 140 is configured to send the payment request.

The payment request will be sent to a payment account bound to the service application for payment.

The client in the present embodiment may be a client capable of applying the method having Step S110 to Step S140 in the aforementioned embodiment or a first client.

The detection module 110 in the present embodiment may correspond to a human-computer interaction interface in an electronic device, for receiving a payment operation output by a user. The human-computer interaction interface may include a keyboard, a mouse, a remote controller, a voice input module, or other human-computer interaction interfaces.

Hardware structures corresponding to the response module 120 and the forming module 130 may be a processor and a storage medium in the electronic device. The processor and the storage medium are connected via an internal communication interface of the electronic device. Executable codes are stored on the storage medium, and the processor may implement functions of the response module 120 and the forming module 130 respectively by executing the executable codes.

The first sending module 140 may correspond to various types of communication interfaces such as a wired communication interface and a wireless communication interface. The wired communication interface may include a cable interface and an optical cable interface. The wireless communication interface may include structures such as a WiFi antenna or Bluetooth antenna.

The client in the present embodiment can send the payment information and the payment request to the payment account bound to the service application according to the payment operation of the user. So, the operations of scanning the payment information or filling in the payment account by utilizing an electronic device such as a mobile phone by the user are avoided, the intelligence of the client is improved, software and hardware resources of the electronic device are better utilized, and the usage satisfaction of the user is improved.

In the present embodiment, the detection module 110 is specifically configured to detect a payment operation for multimedia information when the multimedia information is played. The multimedia information may include information such as a video or a picture. For example, the multimedia information is a video of which the information content is commodity advertisement information or scenic area publicity information. In the conventional art, if the user wants to purchase or order a ticket, an interface of scanning a payment identifier displayed by the electronic device will be accessed or the electronic device will be controlled to quit playing the multimedia information, and to enter a payment interface. Thus, the user or other users focusing on playing of the multimedia information will be disturbed apparently. Moreover, the user operation is relatively complicated due to this operation mode, and the usage satisfaction of the user is low. The client in the present embodiment is adopted for the payment operation, the client will automatically detect a payment operation input by the user, payment information will be acquired on the background of the client without influencing playing of the multimedia information, and a payment request is formed and is sent to a payment account bound to the service application via a network finally. So, the user may pay by using other electronic devices running corresponding payment accounts. Certainly, the client in the present embodiment may ask someone for help in payment by forming the payment request.

For example, when a user is watching a teleplay namely the Empress of China and when the teleplay namely the Empress of China is being played, a makeup picture advertisement is inter-cut at an edge position of a network television via picture information. If the method in the conventional art is adopted, the user needs to make a television pause by means of a button of a remote controller or a network television, and scans a payment QR code corresponding to the picture advertisement by using a mobile phone. After scanning of the mobile phone is completed, a WeChat account, a QQ account, a tenpay account, an alipay account or other accounts having a payment function is utilized to enter a payment interface or to make an order for payment. It is apparent that the user operation of aligning with the television set for scanning is complicated. Playing of the teleplay namely the Empress of China pauses, thereby disturbing watching of other users watching the same teleplay. So, the intelligence of the network television appears to be low, and the usage satisfaction of the user is not high. By utilizing the client in the present embodiment, the user may input an instruction to the detection module, e.g., press a specific control via the remote controller, the network television will detect a payment operation of payment for a product purchased by the user in the makeup picture advertisement. At this time, payment information will be acquired at the background of the network television, for example, the payment QR code is acquired, and a payment request is formed. The payment request is sent to the payment account bound to the service application via a payment platform such as a WeChat platform, a QQ platform or a tenpay platform. At this time, the mobile phone of the user will receive the payment request. The payment request includes necessary payment information of the user such as a payment link, payment identification information or order information. At this time, the user may perform payment by utilizing the mobile phone.

The client in the present embodiment is utilized for payment, so the payment operation of the user can be simplified, and the intelligence of the client and the usage satisfaction of the user are improved.

### Device Embodiment 2

As shown in FIG. 5, the present embodiment provides a client, which includes a detection module 110, a response module 120, a forming module 130 and a first sending module 140.

The detection module 110 is configured to detect a payment operation through a service application.

The response module 120 is configured to acquire payment information in response to the payment operation.

The forming module 130 is configured to form a payment request according to the payment information.

The first sending module 140 is configured to send the payment request.

The payment request will be sent to a payment account bound to the service application for payment.

The client further includes: a first establishment module, configured to establish, before the service application detects the payment operation, a binding relationship between the service application and the payment account.

The first establishment module in the present embodiment is mainly configured to establish a binding relationship between the service application and the payment account. The first establishment module may include a human-computer interaction interface, for receiving a payment account input by a user. The first establishment module may further include an output structure such as a display screen or a voice output structure. Identification information of the service application is output, and according to the identification information of the service application output on the basis of the first establishment module, a binding relationship is established by utilizing other electronic devices such as a mobile phone. So, the binding relationship may be stored in the client, or may be stored in a server serving the client, specifically for example, a video server providing video playing service.

In some embodiments, the first establishment module is configured to receive identification information of the payment account, and send the identification information to a server.

The identification information will be used by the server for establishing a binding relationship between the service application and the payment account.

In the present embodiment, the first establishment module mainly includes: a human-computer interaction interface for receiving identification information of a payment account, and further includes a communication interface. The communication interface may include various wired or wireless communication interfaces, for sending the identification information of the payment account to the server. The binding relationship between the service application and the payment account is established in the server finally.

Certainly, during specific implementation, the first establishment module may self-establish the binding relationship between the service application and the payment account, and self-determine a payment account waiting for receiving the payment information by querying the binding relationship established on the client locally.

In a word, the present embodiment provides a client, which has the advantages of simple structure and easy implementation.

### Device Embodiment 3

As shown in FIG. 5, the present embodiment provides a client, which includes a detection module 110, a response module 120 and a forming module 130.

The detection module 110 is configured to detect a payment operation through a service application.

The response module 120 is configured to acquire payment information in response to the payment operation.

The forming module 130 is configured to form a payment request according to the payment information.

The first sending module 140 is configured to send the payment request.

The payment request will be sent to a payment account bound to the service application for payment.

The client further includes: an output module, configured to output, after payment succeeds on the basis of the payment request, information for indicating payment success.

The output module may include various display screens, which output information for indicating payment success by using a display manner. The output module may further include an audio output structure (e.g., loudspeaker), and the information for indicating payment success is output by utilizing the audio output structure.

In the present embodiment, by arrangement of the output module, the user can be informed, in time, of a situation whether payment succeeds currently, thereby further improving the intelligence of the client and the usage satisfaction of the user.

In some embodiments, the output module may be further configured to output, when the payment account does not perform payment for the payment request for a specified time period, information for prompting payment or information for cancelling payment.

Here, the information for prompting payment or the information for cancelling payment is output to remind the user of payment or payment cancellation, thereby avoiding the problem that payment cannot be carried out after the payment request is formed, and improving the intelligence of the client and the usage satisfaction of the user again.

### Device Embodiment 4

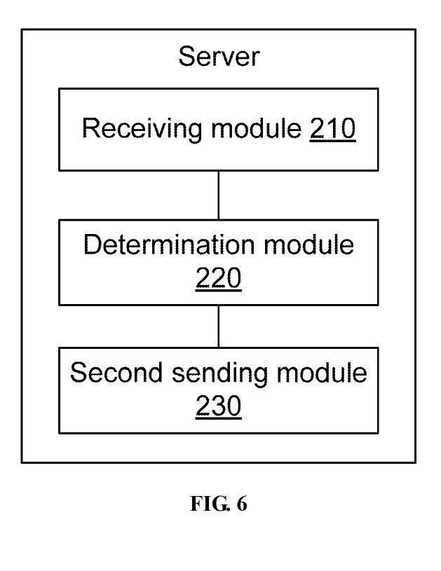

As shown in FIG. 6, the present embodiment provides a server, which includes a receiving module 210, a determination module 220 and a second sending module 230.

The receiving module 210 is configured to receive a payment request sent by a service application.

The determination module 220 is configured to determine a payment account by which the payment request will be received, wherein the payment account is bound to the service application.

The second sending module 230 is configured to send the payment account and the payment request to a payment platform.

The payment request will be sent to the payment account via the payment platform for payment.

The server in the present embodiment may be an electronic device for serving the client in the aforementioned embodiment. The server here not only may refer to an electronic device, but also may refer to a cluster formed by a plurality of electronic devices in general. A network connection is established between the server in the present embodiment and the client in the aforementioned device embodiment or the first client in the method embodiment, and information interaction can be performed with each other.

The server in the present embodiment includes a receiving module 210. The receiving module 210 is a communication interface capable of establishing a communication connection with the client and performing communication with the client, and may be configured to receive the payment request from the client. The communication interface may be various wired communication interfaces or wireless communication interfaces.

The second sending module 230 may be a communication interface sending the payment request to the payment account, and likewise may include various wired communication interfaces or wireless communication interfaces.

The determination module 220 needs to determine the payment account sent by the payment request.

The structure of the determination module 220 varies depending on the manner of determining the payment request.

Two optional structures of the determination module 220 are provided hereinbelow.

Optional Structure 1:

The determination module 220 is configured to query a payment account bound to the service application according to identification information of the service application.

In this case, the determination module 220 may include a storage medium. The storage medium stores information such as identification information of the payment account bound to the service application. The determination module 220 further includes a structure such as a processor having an information processing function such as information query.

Optional Structure 2:

The determination module 220 may include an information parsing structure such as a decoder. The parsing structure is configured to parse the identification information of the payment account, sent by the service application, and determine the payment account. The identification information of the payment account may be received together with the payment request from the client usually, or the payment request and the identification information of the payment account are received from the client respectively.

Apparently, in the present embodiment, two different structures of the determination module 220 are provided. The two structures are both characterized by simple structure, and the payment account can be simply determined.

When the determination module 220 in the client is the aforementioned optional structure 1, the server further includes a second establishment module.

The second establishment module is configured to establish, before the payment request sent by the service application is received, a binding relationship between the service application and the payment account.

A specific structure of the second establishment module in the present embodiment may at least include a storage medium, and a binding relationship between the service application and the payment account needs to be established by information storage. Specifically, for example, the second establishment module is specifically configured to receive identification information, sent by the service application, of the payment account is received, and store the identification information of the service application and identification information of the payment account with correspondence to each other. Herein, storage with correspondence to each other may include establishment of a mapping relationship between the identification information of the service application and the identification information of the payment account. Establishment of the binding relationship between the service application and the payment account via the second establishment module in the present embodiment has the advantages of simple structure and easy implementation.

### Device Embodiment 5

As shown in FIG. 6, the present embodiment provides a server, which includes a receiving module 210, a determination module 220 and a second sending module 230.

The receiving module 210 is configured to receive a payment request sent by a service application.

The determination module 220 is configured to determine a payment account by which the payment request will be received, wherein the payment account is bound to the service application.

The second sending module 230 is configured to send the payment account and the payment request to a payment platform.

The payment request will be sent to the payment account via the payment platform for payment.

The server further includes a forming module.

The receiving module 210 is further configured to receive a payment response which is representative of Having Paid and sent by the payment account via the payment platform.

The forming module is further configured to form information for indicating payment success according to the payment response.

The second sending module 230 is further configured to send the information for indicating payment success to the service application.

The information for indicating payment success will be displayed on a client where the service application runs.

In the present embodiment, the server generates the information for indicating payment success and sends the information to the client. As such, the information for indicating payment success can be displayed via the client in time, the user may conveniently check a payment state, and the utilization rate of software and hardware resources of the server, the intelligence and the usage satisfaction of the user are further improved.

In addition, the forming module in the present embodiment is further configured to form, when a payment response is not received from the payment account for a specified time period, information for prompting payment or information for cancelling payment.

The second sending module 230 is further configured to send the information for prompting payment or the information for cancelling payment to at least one of the payment account and the service application.

The information for prompting payment will be displayed on a client where the service application runs or a client where the payment account runs.

The information for cancelling payment will be displayed on the client where the service application runs or the client where the payment account runs.

Certainly, the forming module for forming the information for indicating payment success and the forming module for forming the information for cancelling payment or information for prompting payment in the present embodiment correspond to the same hardware structure, or may correspond to different hardware structures.

A specific example is provided hereinbelow in conjunction with any one of the abovementioned embodiments.

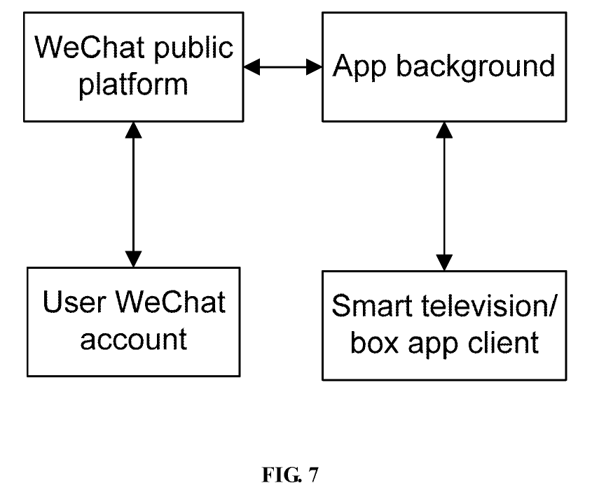

FIG. 7 shows a communication system capable of adopting the information processing method in the present embodiment. In the communication system shown in FIG. 7, a smart television/box app client is included. The box here is a television box equipped for a network television. The box app client is a client formed by utilizing hardware of the box and software running on the box and corresponding to an app background. The app background in the present embodiment is the aforementioned server, usually a server located on a network side. The box app is the aforementioned service application.

In the present example, a WeChat official account runs on the app background. So, the app background may perform information interaction with a WeChat official platform on the basis of the WeChat official account. A WeChat account may include a WeChat official account and a WeChat personal account. Usually, the WeChat official account is a WeChat group account, or an official account for enterprises and other organizations. The WeChat personal account is a WeChat account of a user usually. A platform providing WeChat service for the WeChat account may be called as a WeChat platform. The WeChat platform includes the WeChat official platform. The WeChat official platform is used for providing WeChat service for the WeChat official account. Here, it may be understood as WeChat communication performed via the WeChat official platform. The WeChat account of at least one party is the WeChat official account. A user WeChat account in FIG. 7 is a payment account in the aforementioned embodiment. The user WeChat account here may be the aforementioned WeChat personal account or may be the WeChat official account. When the user WeChat account is the WeChat official account, the user WeChat account may be an official payment account of an enterprise or other group organizations.

A method for payment on the basis of the communication system shown in FIG. 7 in the present embodiment is provided hereinbelow specifically.

Binding is performed. For example, a WeChat QR code provided by an app background is scanned via a box app, such that the box app is bound to a WeChat official account; and meanwhile, binding between the box app and a user WeChat account will be established.

Payment is performed. For example, after a user finishes selection on a television, a television box app client will send payment information to the user WeChat account, so the user can perform payment without scanning a QR code. User selection and shopping on the television here may include: inputting a payment operation to the client; and at this time, the client needs to perform detection.

In a step a, the box app detects the payment operation to form a payment request.

In a step b, a smart television/box app client sends the payment request to the app background.

In a step c, the app background sends the payment request to a WeChat official platform.

In a step d, the WeChat official platform pushes the payment request to the user WeChat account.

In a step e, payment is performed by using the user WeChat account.

In a step f, a WeChat user sends a payment response to the WeChat official platform.

In a step g, the WeChat official platform sends the payment response to the app background.

In a step h, the app background determines payment success, and executes a subsequent payment operation.

The app background may be a server capable of providing background video playing service for the box app, for storing a binding relationship between the user WeChat account and the box app, checking the truth of the payment request sent by the box app, forwarding the payment request to the WeChat official platform, receiving a payment result from the WeChat official platform, and informing the box app client of the payment result. Herein, the WeChat official platform will forward the payment request to the user WeChat account.

Establishment of the Binding Relationship:

Before payment, a corresponding relationship between the box app and the user WeChat account is established, and the corresponding relationship is stored on the app background (appID->wechatOpenID). Then, the payment request of the box app will be forwarded to the user WeChat account bound to the box app.

In order to improve the payment safety, the app background needs to ensure the truth of the payment request of the client, and it may be guaranteed that the request is not counterfeit by utilizing conventional ticket-changing and ticket-checking mechanisms. Herein, the ticket-changing and ticket-checking mechanisms may be subject to the conventional art, which will not be elaborated herein.

App Background Payment Request:

Payment is requested by utilizing an existing payment interface of WeChat. The WeChat payment interface has the characteristics of counterfeit prevention and the like so as to ensure the safety. After payment via the user WeChat account is completed, the app background will be informed of the result asynchronously.

The WeChat payment is asynchronous. The box app does not need to wait for a payment result after sending the payment request. After payment is completed, the app background will inform the box app of the payment result by using an app message channel (or an existing message channel of a smart television). If an order is not paid after being made, the app background will push an informing message to the user WeChat account and a client where the box app is located for prompting for payment. If payment expires, the order may be cancelled.

In some embodiments provided by the disclosure, it is to be understood that the disclosed devices and methods may be implemented in another manner. The device embodiment described above is only schematic. For example, division of the modules is only logic function division, and other division manners may be adopted during practical implementation. For example, multiple modules or components may be combined or integrated into another system, or some characteristics may be neglected or not executed. In addition, coupling or direct coupling or communication connection between each displayed or discussed component may be indirect coupling or communication connection, implemented through some interfaces, of the devices or the modules, and may be electrical and mechanical or adopt other forms.

The abovementioned modules described as discrete parts may or may not be physically separated. The parts displayed as modules may or may not be physical modules, and namely may be located in the same place, or may also be distributed to multiple network modules. Part or all of the modules may be selected to achieve the purpose of the solutions of the embodiment according to a practical requirement.

In addition, the various function modules in each embodiment of the disclosure may be integrated into a processing module, or the modules may exist separately, or two or more modules may be integrated into a module. The abovementioned integrated module may be implemented in a hardware form, and may also be implemented in form of a function module combining hardware with software.

Those skilled in the art should know that: all or part of the steps of the abovementioned method embodiment may be implemented by instructing related hardware through a program, the abovementioned program may be stored in a computer-readable storage medium, and the program is executed to execute the steps of the abovementioned method embodiment; and the abovementioned storage medium includes: various media capable of storing program codes such as mobile storage equipment, a Read-Only Memory (ROM), a Random Access Memory (RAM), a magnetic disk, an optical disk or the like.

The embodiments of the disclosure also disclose a computer storage medium. A computer program is stored in the computer storage medium. The computer program is used for executing various information processing methods provided in the embodiments of the disclosure. For example, the information processing method as shown in FIG. 1 to FIG. 4 is executed. The computer storage medium in the present embodiment may be any one of the aforementioned computer storage media, a non-instant storage medium alternatively.

The above is only the specific implementation of the disclosure and not intended to limit the scope of protection of the disclosure. Any modifications made according to the principle of the disclosure shall be understood as falling within the scope of protection of the disclosure.

What is claimed is:

1. An information processing method, comprising:
detecting, by a client, a payment operation through a service application running on the client;
acquiring, by the client, payment information in response to the payment operation;
forming, by the client, a payment request according to the payment information; and
sending, by the client, the payment request,
the payment request being sent by the client to a payment account bound to the service application for payment.

2. The method according to claim 1, wherein the step of detecting, by a service application, a payment operation comprises:
when multimedia information is played, detecting a payment operation for the multimedia information.

3. The method according to claim 1, wherein the method further comprises:
establishing a binding relationship between the service application and the payment account before the service application detects the payment operation.

4. The method according to claim 3, wherein the step of establishing a binding relationship between the service application and the payment account before the service application detects the payment operation comprises:
receiving identification information of the payment account; and
sending the identification information to a server,
the identification information being used for establishing, by the server, a binding relationship between the service application and the payment account.

5. The method according to claim 1, wherein the method further comprises:
after payment succeeds on the basis of the payment request, outputting information for indicating payment success.

6. The method according to claim 1, wherein the method further comprises:
when the payment account does not perform payment for the payment request for a specified time period, outputting information for prompting payment or information for cancelling payment.

7. An information processing method, comprising:
receiving, by a server, a payment request sent by a service application;
determining, by the server, a payment account by which the payment request will be received, wherein the payment account is bound to the service application; and
sending, by the server, the payment account and the payment request to a payment platform,
the payment request being sent to the payment account via the payment platform for payment.

8. The method according to claim 7, wherein the step of determining a payment account by which the payment request will be received comprises:
querying a payment account bound to the service application according to identification information of the service application.

9. The method according to claim 8, wherein the method further comprises:
before the payment request sent by the service application is received, establishing a binding relationship between the service application and the payment account.

10. The method according to claim 9, wherein the step of establishing a binding relationship between the service application and the payment account comprises:
receiving identification information, sent by the service application, of the payment account; and
storing the identification information of the service application and identification information of the payment account with correspondence to each other.

11. The method according to claim 7, wherein the step of determining a payment account by which the payment request will be received comprises:
parsing the identification information, sent by the service application, of the payment account, and determining the payment account.

12. The method according to claim 7, wherein the method further comprises:
receiving a payment response which is representative of Having Paid and sent by the payment account via the payment platform;
forming information for indicating payment success according to the payment response; and
sending the information for indicating payment success to the service application,
the information for indicating payment success being displayed on a client where the service application runs.

13. The method according to claim 7, wherein the method further comprises:
when a payment response is not received from the payment account for a specified time period, forming information for prompting payment or information for cancelling payment; and
sending the information for prompting payment or the information for cancelling payment to at least one of the payment account and the service application,
the information for prompting payment being displayed on a client where the service application runs or a client where the payment account runs, and
the information for cancelling payment being displayed on the client where the service application runs or the client where the payment account runs.

14. A client, comprising:
one or more processors;
memory; and
one or more program modules stored in the memory and to be executed by the one or more processors, the one or more program modules including:
a detection module, configured to detect a payment operation through a service application running on the client;
a response module, configured to acquire payment information in response to the payment operation;
a forming module, configured to form a payment request according to the payment information; and
a first sending module, configured to send the payment request,
the payment request being sent to a payment account bound to the service application for payment.

15. The client according to claim 14, wherein
the detection module is configured to detect, when multimedia information is played, a payment operation for the multimedia information.

16. The client according to claim 14, wherein the one or more program modules further comprise:
a first establishment module, configured to establish, before the service application detects the payment operation, a binding relationship between the service application and the payment account.

17. A server, comprising:
one or more processors;
memory; and
one or more program modules stored in the memory and to be executed by the one or more processors, the one or more program modules including:
a receiving module, configured to receive a payment request sent by a service application;
a determination module, configured to determine a payment account by which the payment request will be received, wherein the payment account is bound to the service application; and
a second sending module, configured to send the payment account and the payment request to a payment platform,
the payment request being sent to the payment account via the payment platform for payment.

18. The server according to claim 17, wherein
the determination module is configured to query a payment account bound to the service application according to identification information of the service application.

19. The server according to claim 18, wherein the one or more program modules further comprises:
a second establishment module, configured to establish, before the payment request sent by the service application is received, a binding relationship between the service application and the payment account.

20. The server according to claim 18, wherein
the second establishment module is configured to receive identification information, sent by the service application, of the payment account is received, and store the identification information of the service application and identification information of the payment account with correspondence to each other.
